(19) United States
(12) Patent Application Publication
(10) Pub. No.: US 2005/0096202 A1
(43) Pub. Date: May 5, 2005

(54) Device for the simultaneous, continuous measurement and regulation of the acetate and triacetine level in filter rods of the tobacco-processing industry

(76) Inventors: Eberhard Teufel, Gundelfingen (DE); Wolfgang Sexauer, Freiburg (DE); Manfred Gerlitzki, Freiburg (DE); Rainer Herrmann, Hamburg (DE)

Correspondence Address: DARBY & DARBY P.C., P. O. BOX 5257, NEW YORK, NY, 10150-5257, US

(21) Appl. No.: 10/505,467

(22) PCT Filed: Feb. 21, 2003
(86) PCT No.: PCT/EP03/01821

(30) Foreign Application Priority Data
Feb. 21, 2002 (DE) 10207357.0

(51) Int. Cl. B31C 13/00

(52) U.S. Cl. 493/39

(57) ABSTRACT

The invention relates to a device for producing cigarette filters, which comprises a conditioning section (AF) for conditioning the supplied filter tows, a formatting device (F) for producing a wrapped filter strand, a dosing device integrated into the conditioning section for dosing a softener. The device further comprises sensors that detect the mass flow of filter tow material M1 and sensors that detect the sum of the mass flow from filter tow material and softener compound M2. A measuring and regulation unit is coupled with the sensors for measuring the mass flows (M1 and M2) in such a manner that both the filter material and the softener compound can be measured and regulated independently.

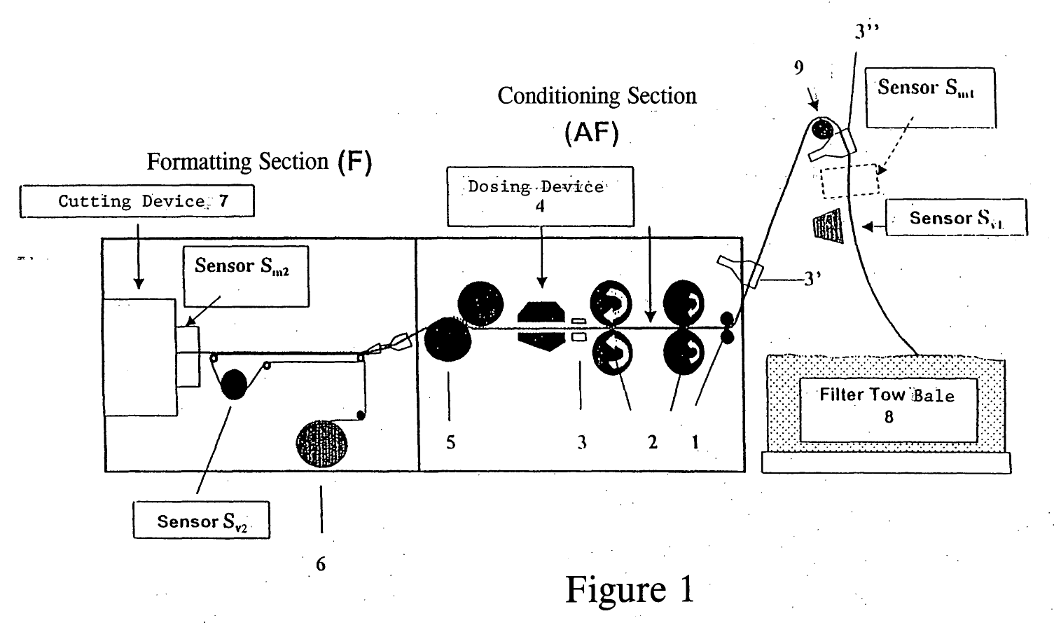

The invention relates to a device for the simultaneous, continuous measurement and regulation of the acetate and triacetin levels during the production of filter rods, especially for the use in the tobacco industry.

Cigarette filters are an essential, quality-relevant part of cigarettes so that great efforts are undertaken to optimize the manufacturing method for filter rods when it comes to quality. In doing so, a most goal-oriented regulation of the method has to be considered, which of course depends on a most precise and fast characterization of the product quality. In the optimal case this is done through an online method.

For the characterization of filter rods in the tobacco industry, parameters such as diameter, acetate weight and triacetin value as well as tractive resistance are evaluated. In determining the acetate weight, tractive resistance and triacetin content usually offline procedures are applied. The determination of the acetate weight is done gravimetrically by evaluating the gross weight of the rods and by subtracting the mass of the wrapping paper, adhesive and triacetin. Paper and adhesive amounts are likewise evaluated in a gravimetric fashion, wherein these are largely parameters that are irrelevant to the process. In the determination of the triacetin value different methods are applied. For one the weight of a defined number of filter rods with and without triacetin is evaluated. The difference between the two measurements then results in the triacetin content. This method has the disadvantage of being feasible only occasionally or resulting in a high amount of waste when used frequently. Beyond that methods are available for the evaluation of triacetin in finished filter rods. By way of example, the extraction of triacetin with a suitable solvent and the determination of the triacetin content by a laboratory method such as gas chromatography can be mentioned.

Another procedure that could be named is the determination of the softener content by measuring the reflection of infrared beams in the near infrared range (see e.g. CANON A. B.; HUGHES I. W.: On-line measurement of triacetin in cigarette filter rods using near infrared reflectance spectroscopy); Tob. Chem. Res. Conf., 1987). This method has the considerable disadvantage of being a surface measuring method and that the infrared beam penetrates only a few wavelengths into the product to be measured. This causes the measurement result to strongly depend on the migration behavior of the softener, but also on the fineness of the fibers and the packing density of the employed filter material.

All these methods have the disadvantage that they only reflect momentary images of the current production since they are all performed off-line.

For this reason on-line determination procedures for acetate weight, which may also be used for method regulation purposes, have been used for quite some time now. For example DE 28 15 025 describes the measurement of the density and herewith mass of the finished filter strand using a beta ray detector. This procedure thus allows a determination of the mass of the finished filter rod, wherein the mass in this case is composed successively of the acetate mass and the applied triacetin quantity. In this procedure the off-line process described above is employed for the determination of the triacetin content. With certain restrictions, the method is also already suited for regulating the overall mass of the filter rods, but with the limitation that the density evaluation using a beta ray detector cannot detect moisture fluctuations in the product to be measured.

Another quasi on-line determination is described in DE 31 49 670 A1. Here the applied amount of acetate is determined by positioning the filter tow material on a scale and continuously recording the consumption of material throughout the manufacturing process. The simultaneous determination of the number of cuts (filter rod segments) per time unit allows a conclusion of the amount of acetate used per filter rod by combining these two measured variables.

If in addition to that the end weight of the filter rods is determined through an external weighing process, the difference between material used and actual filter rod mass results in the applied amount of triacetin. This procedure as well has the disadvantage that it can be referred to as an on-line process only conditionally since it requires an additional off-line weight determination of the finished filter rods. The frequency of triacetin values available with this method is determined by the frequency of the external gross weight determination processes. Since for this process in turn filter rods have to be removed from the product stream, this evaluation is likewise associated with a considerable amount of waste. In addition, the scale has the disadvantage that malfunctions occurring from certain tow defects may not be detected. One of these malfunction factors would be e.g. the failure of a spinning nozzle during the production process of the filter tow with the result that for a short time 2 to 5% of the nominal overall titer is missing. This results in the end in approx. 2.5% lighter filter rods while using the same amount of material, measured based on the weight reduction of the bale. As a result this would provide the incorrect perception of too low a triacetin content. Additionally, short-term fluctuations as well the amount of acetate and the amount of triacetin cannot be determined with the help of this method.

Another disadvantage of this procedure is that in the determination of the acetate quantity the moisture level of said acetate is not taken into consideration. The equilibrium moisture content of cellulose acetate under normal conditions is approx. 5.5% by weight. Under conventional production practices the starting moisture of a filter tow may vary between approx. 3.5 and 7% by weight due to modified process parameters. This variation results in a relative inaccuracy of the afore-mentioned weight evaluations for the triacetin and acetate amounts. To complete the picture it shall also be mentioned here that the end moisture level and therewith the gross weight of the finished filter rods can be influenced significantly by changing process parameters during filter rod production. By way of example parameters such as room climate, processing speed and the temperature and moisture level of the air on the spreading nozzles shall be mentioned.

The present invention is based on the object of eliminating the above-mentioned disadvantages of the state of art and describing a device for the simultaneous, continuous measurement of acetate and triacetin masses and the regulation of the production process.

Pursuant to the invention the object is achieved with a device pursuant to claim 1. The device pursuant to the invention for the production of cigarette filters with simultaneous regulation of the filter material and softener compound, comprising a conditioning section AF for conditioning of the supplied filter tows, a formatting device F for producing a wrapped filter strand, and a dosing device integrated into the conditioning section for dosing a softener compound, is characterized in that the device furthermore comprises sensors that detect the mass flow of filter tow material M₁ and sensors that detect the sum of the mass flow from filter tow material and softener compound M₂, wherein the device contains a measuring and regulation unit that is coupled with the sensors for measuring the mass flows (M₁ and M₂) in such a manner that both the filter material and the softener compound can be measured and regulated independently.

In a preferred embodiment of the invention, viewed in the moving direction of the filter strand, sensors Sₘ₁, Sₘ₂ for detection of the length-related mass m₁, m₂ of the continuous filter strand and sensors Sᵥ₁, Sᵥ₂ for detection of the current speeds v₁ and v₂ of the continuous filter strand are located in front and after the softener dosing unit, wherein each mass flow results from the product from m₁×v₁=M₁ and m₂×v₂=M₂.

In general the employed sensor Sₘ₁, Sₘ₂, Sᵥ₁ and Sᵥ₂ may be arranged in different locations of the overall device, wherein it is essential for the invention that the sensors marked with “1” are always located in front of the dosing unit and the sensors marked with “2” after the same, when viewed in the moving direction of the filter strand. The first mass sensor Sₘ₁ and speed sensor sᵥ₁ may thus be located at any given point between the bale feed area and the dosing unit.

In a beneficial embodiment the sensor Sᵥ₁ for detection of the speed v₁ and the sensor Sₘ₁ for detection of the length-related mass m₁ are arranged directly adjacent.

“Directly adjacent” should be understood such that they are located directly behind one another in the moving direction of the filter strand without another element of the device being located between them. If the sensors work touch-less, it may be possible, if necessary, to measure at the same location. This ensures that speed and length-related mass are measured at one point of the filter strand where identical overall conditions regarding the drawing condition of the filter tows prevail.

For reasons of measuring sensitivity, especially regarding sensor Sₘ₁, it has proven especially favorable if the mass flow M₁ is evaluated before the filter tow enters the conditioning unit AF.

In another beneficial embodiment of the invention the sensor Sₘ₂ is placed directly in front of the cutting device, viewed in the moving direction of the filter strand, and as sensor Sᵥ₂ the measuring unit for the formatting line speed is applied.

The speeds v₁ and v₂ are preferably determined with optical sensors. Such optical sensors have the advantage that measurement of the relative speed between two objects can be done touch-less. In doing so, no mechanical interference with the motion of the filter strand takes place. On such optical sensors the surface structures of the filter strand are typically projected on a grid, where they create light modulation. With the help of a photoelectric element, this light modulation is converted into a frequency that is proportional to the relative speed. Other possibilities for touch-less measurement of the speed of a continuous material strand are feasible, but are not mentioned here.

In principle any sensor that allows the direct or indirect detection of the length-related mass of a continuous material strand may be used as a “mass sensor”.

It is particularly beneficial if apart from the length-related mass also the moisture content of the product to be measured can be determined, simultaneously and independently from the mass determination, since only this way a complete mass assessment can be performed during the production process (moisture, acetate-triacetin mass).

Therefore preferably microwave resonators that are used as mass sensors are employed determine the length-related mass m₁ and m₂.

EP 0 468 023 B1 explains how by measuring two physical effects the length-related mass and the moisture of a product that is located in the microwave field of a microwave resonator can be determined independently from each other. Microwave resonators create a standing wave with the resonance frequency, through which the acetate and/or filter material is moved with the aid of special openings and with product guides lined with dielectric material. Through this special interaction between the standing microwave and the product, the resonance characteristics of microwave resonators are modified. A great advantage of these resonators is that adaptations to a variety of applications are possible through the geometric layout and that this way a large measuring effect and a great penetration depth into the product can be achieved. Moreover, contrary to measuring techniques that do not use the principle of resonance (such as the irradiation or stray measuring techniques), measuring the loss of microwave energy resulting from the absorption into the product has the quality of an exact measured value, which is not given with irradiation measurements due to leakage losses that cannot be determined. The afore-mentioned patent publication provides an entire list of examples for such resonators: For extensive material shapes, as those of the filter tow strand in the entire region of the conditioning section (AF) before the dosing unit, a sensor type whose microwave measurement field can be designed very homogeneously in a measuring gap that is up to 3 cm wide and up to 30 cm long is particularly suited so that the position of the product in the sensor does not matter for the strength of interaction between the microwaves and the product. This “split resonator” is a resonator that is excited in the basic mode of E₀₁₀ and that was cut open in the direction of the wall currents, resulting in a measuring zone with an extremely homogeneous measuring field.

For a lateral one-sided measurement of the acetate strand before application of the softener compound a planar sensor is also suited, comprising a standing wave over a planar surface, the leakage field of which extending from the sensor surface decreases into the space exponentially up to a maximum expansion of 10 cm. Such a sensor is described in EP 0 908 718.

In front of the first spreading nozzle, before the filter tow material is aligned to an extensive strand, it is also possible to use a closed resonator, which is perforated with a plastic probe guide and is excited in the E010 basic mode, thus having a maximum measuring field, i.e. maximum sensitivity, in the probe area.

In the area of the filter strand after application of the softener compound, position Sm₂, the profile sensor is particularly suited; with it especially a high local resolution of below 3 mm in the direction of the filter strand can be reached, and beyond that it is very well suited for measuring the homogeneity of the softener compound application. Such a profile sensor is disclosed for example in EP 0 889 321. Said sensor comprises a through-hole at a right angle to its area extension. The through-hole is delimited by metallic walls extending in the longitudinal direction and is essentially flat. Said resonator is preferably filled with a dielectric. Its thickness is considerably less than its lateral dimensions, i.e. less than the traverse dimension perpendicular to the thickness.

The particular advantages of a microwave sensor with respect to the beneficial embodiment pursuant to claim 8 shall be explained in more detail here. In the case of the microwave resonator measuring technique there are two variables that are direct measured variables: the change in resonance frequency A and the increase in the half-width value B of the resonance curve over the resonator at empty. The first effect of the resonance frequency increment A depends above all on the shortening of the wavelength by the dielectric product that is currently located in the measuring field of the resonator (i.e. on the so-called real part of the dielectricity constant). The second effect B is caused by the conversion of microwave energy into heat, which can be measured only accurately with the resonator method (the “microwave oven effect” or the so-called imaginary part of the dielectricity constant). Since both variables are equally proportional to the mass of the product in the measuring field, both are also suited for mass measurement. In principle parameter A is used for this. On the other hand both measured variables are dependent in different fashions is on the moisture level. Thus the quotient of both variables B/A supplies a mass-independent measured variable that is dependent only on moisture and can be calibrated against the material moisture level. With this variable on the other hand the influence of moisture on the mass value A can be compensated for so that two independent measured variables can be provided: moisture, which is independent from mass, and mass, which is independent from moisture. Moreover the moisture information of the incoming acetate strand can be utilized to compensate for moisture fluctuations among the different acetate bales as well as within the bale by regulating the mass flow.

A great advantage of the microwave measuring method is the constancy of the performed calibration and its independence from fluctuations of material parameters, such as e.g. the change in manufacturing parameters for acetate, e.g. its overall titer or its thread strength. The measuring method has recently been optimized so as to achieve a very high measuring speed and precision, and now after 0.1 milliseconds a new moisture and mass value can be issued, respectively, i.e. 10,000 values per second.

Alternatively density measurements can also be performed by means of beta radiation. And finally also an optical sensor, on which the density is detected by means of stray light measurements with infrared radiation, can be used as a mass sensor. These sensors are well known to those skilled in the area of metrology and should therefore not require further explanations. The last two methods, however, have the disadvantage that they do not detect the moisture of the filter tow so that the triacetin determination is subject to greater inaccuracy than in the case of the microwave method.

Pursuant to another preferred embodiment of the invention the mass flow M₁ can also be determined by means of bale scales pursuant to DE 31 49 670 A1, wherein the previously mentioned limitations with respect to moisture assessment apply.

Pursuant to the invention the output signals of all sensors are fed either to a regulation unit and/or a display unit. If a regulation unit is present, an automatic regulation of the method that is conducted with the device pursuant to the invention may be performed, which is especially beneficial under production conditions. Alternatively it is also possible for an operator to personally record the signals that are depicted with the display unit and perform the corresponding regulation. When both afore-mentioned features are available, a control of the automatic regulation may be conducted with the display unit.

In a beneficial embodiment, the regulation unit is coupled with the drive unit of the conditioning section (AF) and the gear pump, which supplies the dosing device with the required quantity of triacetin.

The operating principle of the inventive device will be explained in the following in more detail with reference to the attached drawing. The only FIGURE in the drawing shows an embodiment of a device pursuant to the invention for the production of cigarette filters.

A conventional filter rod machine, as it is known from the prior art, operates as follows:

The filter tow that is supplied to the filter rod machine is pulled from a bale 8 and fed into the conditioning section (AF) via a so-called boom 9. In front of the spreading nozzle 3″ the sensors Sᵥ₁ and Sₘ₁ are arranged in sequence next to each other.

The conditioning section (AF) generally comprises two spreading nozzles 3 and 3′, a pair of brake rollers 1, which pre-draw the filter strand, as well as pairs of drawing rollers 2, which operate at different speeds and subject the filter strand to a drawing process. The drawing rollers can be equipped with a thread-like surface so that only parts of the-spread filter strand passing through are seized and drawn. This way the individual filament groups, which make up the filter strand, are shifted in relation to each other. Moreover the conditioning section comprises a pair of deflection rollers 5 at its output, by means of which the conditioned filter strand is deflected in a direction that is suitable for entry into the feed nozzle and the feed fingers of the downstream formatting device F.

The drawing rollers 2 as well as the deflection roller 5 are driven rollers, which are driven in relation to one another at a fixed speed ratio.

In the downstream formatting device F the filter strand is gathered to the diameter of the future cigarette filter, wrapped with paper, and subsequently the filter rods are cut to the required length in a cutting device 7. The sensor Sₘ₂ is arranged directly in front of the cutting device 7. A textile belt, called a formatting line, which firmly encloses the filter strand during the gluing operation, is used as mentioned above as the conveying means for the filter strand. As already mentioned, the speed of said conveying means corresponds to the speed of the filter strand in the formatting device and hence past the dosing device 4. Said speed is measured with the sensor Sᵥ₂.

Metering of the acetate mass takes place in the filter rod machines pursuant to the prior art by modifying the difference in speed between the conditioning section (AF) and the formatting section (F), wherein generally that of the formatting section (F) is kept constant.

The acetate mass, however, can also be varied with other measures. EP 0 629 356 B1 for example describes the regulation of the acetate mass by modifying the brake roller pressure on the pair of brake rollers 1.

The dosing device 4 is preferably arranged between the drawing rollers and the deflection rollers in the conditioning section. The softener is hence applied on the completely spread filter strand. The dosing device generally consists of an atomizing housing, in which for example rotating brushes are arranged, which serve the fine atomization of the softener compound and its dispersion onto the spread fiber strand. Generally triacetin or TEGDA (triethylene glycol diacetate) are used as the softener compounds. A complete list of possible softeners can be found in DE 19951062 A1.

The quantity of softener that is required for this process is generally fed to the dosing device 4 by means of a gear pump. Metering of the softener quantity hereby occurs through a change in the rotational speed of the drive unit of said gear pump.

The device pursuant to the invention enables a simultaneous regulation of the filter material and/or acetate quantity and of the softener quantity during the production of filter rods.

Generally it is true that the mass flow of filter tow material in all areas of the device is constant. The following is true for the products M₁ and M₂ from mass and speed as long as no softener is used:
M₁=M₂

As soon as a softener is used:
M₁<M₂,
wherein the difference between M₁ and M₂ represents a measure for the amount of softener per filter rod.

The following applies:
W=K×(M₂−M₁)+C,
wherein W is the amount of softener in mg per filter rod, and K and C are factors that are determined by calibration. These calibration factors are variables that result from the sensor characteristic.

Calibration hence makes it not only possible to regulate the softener content per filter rod, but also to measure it quantitatively continuously, regardless of the filter tow specification that is used.

A similar rule applies for the mass of used filter tow material M per filter rod. It has a linear dependency on the product M₁.

The following applies:
M=K₁M₁+C₁,
wherein K₁ and C₁ in turn have to be determined by calibration in accordance with the sensor characteristic.

A regulation that is performed with the device pursuant to the invention should be performed such that the products M₁ and M₂ are each kept constant.

In practice it has turned out that during regulation essentially three cases may arise:
1. At a constant speed of the conditioning section (AF) and the formatting section (F) the product M₂ changes while M₁ remains the same. This is a sign that too little or too much softener was added. In this case the rotational speed of the gear pump of the dosing device must be adjusted such that the product M₂ is returned to the original quantity.
2. Both the product M₁ and the product M₂ change and the signal of the speed sensor Sᵥ₁ remains constant, while the signal Sₘ₁ changes. In this case a thread breakage has occurred. This means the failure of a spinning nozzle during the manufacturing process of the filter tow with the consequence that in the short term 2 to 5% of the nominal overall filter is missing. For the expert the effects of such a malfunction are clearly foreseeable. Without regulation, this will lead to a drop in the acetate content of the filter rod, associated with decreased tractive resistance.
3. Both the product M₁ and the product M₂ change, wherein the signal of the speed sensor Sᵥ₁ changes and Sₘ₁ remains constant. In this case the cause is a change in the crimping index of the filter strand. This failure as well leads without regulation to a change in the acetate content of the filter rod and in the tractive resistance, as is clearly detectable for those skilled in the art.

In the latter two cases the speed of the conditioning section (AF) should be adjusted such that the product M₁ is returned to the original value.

Of course in theory all three cases can also occur simultaneously. In this very unlikely case, M₁ will first be returned as described to the original value and subsequently another regulation as described in case 1 will be performed for M₂.

With some additional calculations also a product-related and process-related moisture correction can be performed with the use of microwave sensors, as mentioned above. For this, however, it will be required to prepare sensor-specific calibration curves. A more detailed illustration of the method is foregone at this point.

In the case of a thread breakage (case 2), the regulation can be designed, likewise with some additional calculations, such that it is not a constant acetate weight that is achieved as the target variable, but a constant tractive resistance. This type of regulation presupposes that the dependencies of tractive resistance, acetate weight and overall titer are known. Such calculation models exist. One of them is marketed by Rhodia Acetow under the name “Cable©”.

1. A device for producing cigarette filters, comprising a conditioning section (AF) for conditioning supplied filter tows, a formatting section (F) for producing a wrapped filter strand, and a dosing device (4) integrated into a conditioning section for dosing a softener, wherein the device further comprises sensors that detect mass flow of filter tow material M₁ as well as sensors that detect a sum of the mass flow from filter tow material and softener compound M₂, and wherein the device comprises a measuring and regulation unit that is coupled with the sensors for measuring the mass flows (M₁ and M₂) in such a manner that both the filter material and the softener compound can be measured and regulated independently.

2. The device pursuant to claim 1, wherein the device, when viewed in the moving direction of the filter strand, in front of and after the dosing device (4), for the softener sensors (Sₘ₁; Sₘ₂) that detect the length-related mass m₁, m₂ of the continuous filter strand and sensors (Sᵥ₁; Sᵥ₂) that detect the current speeds v₁ and v₂ of the continuous filter strand are provided, wherein the respective mass flow results from the products of m₁×v₁=M₁ and m₂×v₂=M₂.

3. The device pursuant to one of the claim 2, wherein the sensor (Sᵥ₁) that detects the speed v₁ and the sensor (Sₘ₁) that detects the length-related mass m₁ are arranged directly adjacent.

4. The device pursuant to claim 2, wherein the sensors (Sₘ₁; Sₘ₂) that detect the length-related mass m₁ and/or the speed v₁ are arranged before entry into the conditioning section (AF).

5. The device pursuant to claim 2, wherein the formatting device (F) comprises a cutting device and that the sensor (Sₘ₂), when viewed in the moving direction of the filter strand, is arranged directly in front of the cutting device and that as sensor (Sᵥ₂) the measuring unit for the formatting line speed is used.

6. The device pursuant to claim 2, wherein the sensors (Sᵥ₁; Sᵥ₂) that detect the current speeds v₁ and v₂ of the continuous filter strand are optical speed sensors.

7. The device pursuant to claim 2, wherein as the sensor (Sₘ₁ and/or Sₘ₂) that detects the length-related mass m₁ and/or m₂, a sensor is selected that is suited to determine apart from the length-related masses also the moisture content of the current product to be measured.

8. The device pursuant to claim 2, wherein the sensor (Sₘ₁ and/or Sₘ₂) is a microwave sensor.

9. The device pursuant to claim 8, wherein the microwave sensor is a split resonator.

10. The device pursuant to claim 8, wherein the microwave sensor comprises a closed, tube-shaped resonator that is perforated with a plastic probe guide.

11. The device pursuant to claim 8, wherein the microwave sensor is designed as a planar sensor.

12. The device pursuant to claim 8, wherein the microwave sensor is designed as a profile sensor. The device

13. The device pursuant claim 2, wherein the sensor (Sₘ₁ and/or Sₘ₂) that detects the length-related mass m₁ and/or m₂ of the continuous filter strand is a β-radiation source as well as a β-radiation detector.

14. The device pursuant to claim 1, wherein bale scales are used as a sensor for determining the mass flow M₁.

15. The device pursuant to claim 1, wherein said device comprises a regulation unit for the automatic regulation of the filter material and softener mass, which is coupled at its output both to the conditioning section (AF) and the dosing section (4).
